(19) United States
(12) Patent Application Publication
(10) Pub. No.: US 2007/0205305 A1
(43) Pub. Date: Sep. 6, 2007

(54) Paint spray system

(75) Inventor: Michael Vagedes, Florence, KY (US)

Correspondence Address: WOOD, HERRON & EVANS, LLP, 2700 CAREW TOWER, 441 VINE STREET, CINCINNATI, OH, 45202, US

(73) Assignee: RBL Products, Inc., Detroit, MI (US)

(21) Appl. No.: 11/367,818

(22) Filed: Mar. 3, 2006

(51) Int. Cl. A62C 13/62; G01F 11/00

(52) U.S. Cl. 239/302; 222/321.1

(57) ABSTRACT

A container for a paint spray system includes a filter which is sonically welded to a base of the container. The filter includes an annular rim that fits within a recessed portion of the cup surrounding the outlet opening of the cup. This is adapted to be attached to a paint sprayer, allowing quick interchange of coating materials and further insuring that all of the paint will flow through the filter for use.

### BACKGROUND OF THE INVENTION

Gravity feed paint sprayers use a spray gun with a reservoir of coating material, most frequently paint, powered by compressed air to spray the coating material. The compressed air draws the coating material from the reservoir and projects it toward a surface. Generally referred to as paint sprayers, these devices are used in a wide variety of applications, in particular, auto body shops. The reservoir is generally a removable cup that holds the paint or coating material which can be directed through a filter. Recently, it has been preferred to use disposable reservoirs, ones made of plastic that can be discarded. These are also designed to be removed and serve as a temporary storage containers for unused paint.

Generally, some type of filter or strainer is used to remove any undesirable particulate material that may be in the paint. This is particularly important for auto body shops where any particulate material will form an imperfection on the car surface. Typical paint spray reservoirs include those disclosed in Petrie et al. U.S. Pat. No. 6,595,441 and Joseph U.S. Pat. No. 6,820,824. Another such device is disclosed in PCT application WO2004/052552. This application discloses a plastic paint reservoir with a removable cap. It includes a filter which must be manually inserted within the cup. The filter is designed to allow all of the paint within the reservoir to pass through the filter.

### SUMMARY OF THE INVENTION

The present invention is premised on the realization that a paint spray system with a disposable reservoir can be provided wherein the filter is formed as part of the cup, sonically welded to the base portion. More particularly, the filter comprises a plastic frame that has an annular base. The cup itself has a recessed portion within the base which receives the annular member. This is sonically welded to the cup providing filter material at the very base of the reservoir allowing all paint to be removed therefrom. The device is particularly suited for a wide variety of different paint spray systems, and can be used with an adaptor on almost any paint spray system.

The objects and advantages of the present invention will be further appreciated in light of the following detailed description and drawings, in which:

### BRIEF DESCRIPTION OF THE DRAWINGS

FIG. 1 is a perspective of the present invention attached to a spray gun, which is in phantom;

FIG. 2 is a side elevational view partially broken away of the reservoir for use in the present invention; and

FIG. 3 is a perspective view of the cap used in the present invention.

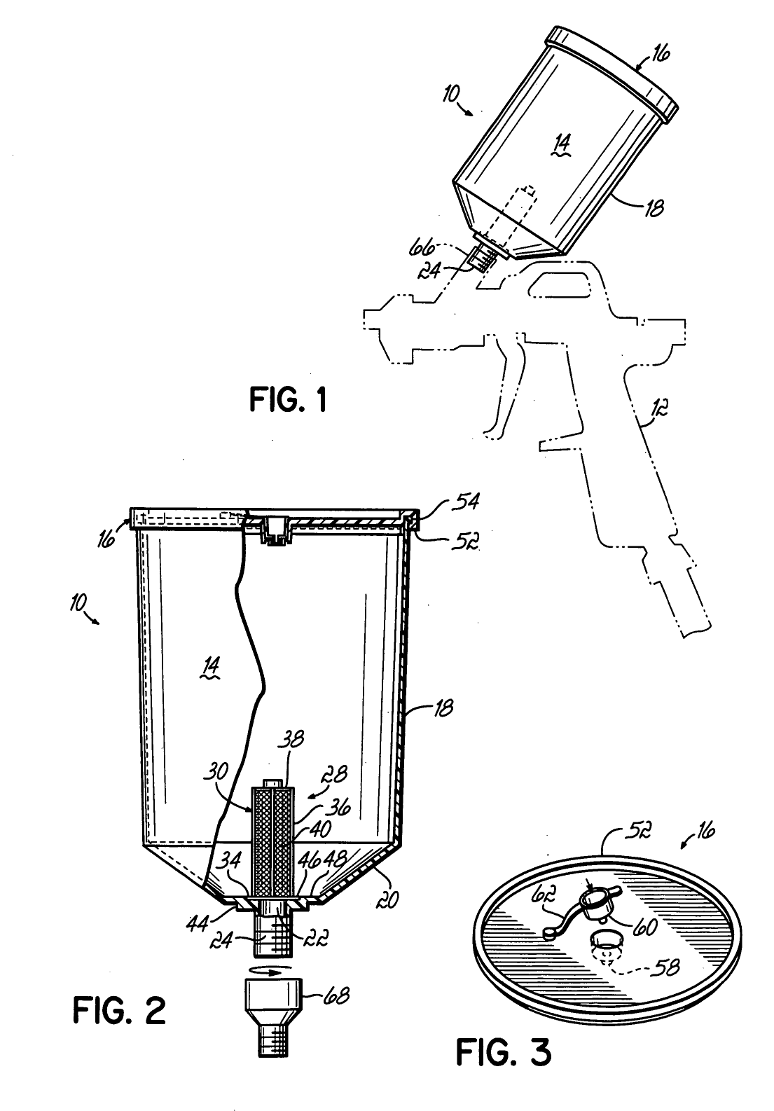

### DETAILED DESCRIPTION OF THE INVENTION

As shown more particularly in the Figures, a coating material container 10 is adapted to be attached to a spray gun 12 (shown in phantom) to be used in a paint spray system. The container 10 itself includes a body portion 14 covered at one end with a removable lid 16. The side wall 18 of body 14 extends from the lid down to a sloped base 20 which leads to an outlet opening 22. The outlet opening 22 leads to an externally threaded connector port 24.

A filter 28 covers the outlet opening 22. The filter more particularly includes a plastic frame 30 having an annular base 34. The frame includes longitudinal frame members 36 which lead from the annular base up to a top plastic disk 38. Within the filter 28 is a filter material 40 which extends from the annular base up to the top disk.

The base 20 of container 10 includes an annular recessed portion 44 which surrounds the opening 22. The filter is located with the annular base 34 received within the recessed portion 44. This leaves the top surface 46 of the annular base 34 flush with the top surface 48 of base 20. More particularly, the annular base 34 of filter 28 is permanently fixed to base 20 by welding or with an adhesive. Preferably, sonic welding is employed.

The lid 16 includes a peripheral rim 52 which is adapted to snap fit onto an edge 54 of container 10. In the center of the lid 16 is a vent hole 58 which can be closed with a plug 60 held to the lid by a flexible tether 62.

The container 10 is attached to the spray gun 12 by threading port 24 onto a threaded connector 66 of spray gun 12. In the event that the threaded connector 66 of a spray gun is not sized to mate with the externally threaded port 24, an adaptor 68 can be employed. Once attached to the spray gun, lid 16 is removed and reservoir 10 is filled with paint. The lid 16 is snapped back onto body 14. The paint can then be applied by using spray gun 12.

Because the surface 46 of filter 28 is flush with the bottom surface 48 of the sloped base 20 of Container 10, all of the paint can be drawn into the gun through the filter. This will eliminate the concern for a small amount of paint being left in the reservoir. Further, the filter being sonically welded in place eliminates the need to manually insert the filter within the bottom of the cup, a procedure that is somewhat difficult and requires a special tool.

After painting is complete, if any paint does remain in the cup and there is reason to save the paint, one can simply place a plug (not shown) into the interior of port 24 and close the vent hole 58 with plug 60, which keeps the paint material in the container and protects it from the air. This allows for quick, easy change over between coating materials, if desired.

This has been a description of the present invention along with the preferred method of practicing the present invention. However, the invention itself should only be defined by the appended claims, WHEREIN

We claim:

1. A paint container adapted to attach directly to a paint gun
said container having a cylindrical body portion and conical base, an outlet extended from a center of said conical base of said body portion, and a filter cartridge;
said filter cartridge including a cylindrical plastic frame supporting a filter material, said frame having an annular base extended radially outward from said frame said filter material exposed above said annular base wherein said annular base is permanently fixed to an annular recess at the center of said conical base.

2. (canceled)

3. The paint container claimed in claim 5 wherein said body portion includes a snap-on lid opposite said conical base.

4. (canceled)

5. The paint container claimed in claim 1 wherein said body portion is integral with said conical base.
